(19) United States
(12) Patent Application Publication
(10) Pub. No.: US 2011/0150137 A1
(43) Pub. Date: Jun. 23, 2011

(54) ARCHITECTURE OF MULTI-POWER MODE SERIAL INTERFACE

(75) Inventors: Chien-Hong Lin, Hsinchu (TW); Chih-Wei Hsu, Hsinchu (TW); Yuan-Heng Sun, Taipei (TW)

(73) Assignee: INDUSTRIAL TECHNOLOGY RESEARCH INSTITUTE, Hsinchu (TW)

(21) Appl. No.: 12/968,451

(22) Filed: Dec. 15, 2010

Related U.S. Application Data
(60) Provisional application No. 61/287,347, filed on Dec. 17, 2009.

(30) Foreign Application Priority Data
Nov. 25, 2010 (TW) 099140834

(51) Int. Cl. H04L 27/00

(52) U.S. Cl. 375/316

(57) ABSTRACT

In one embodiment of an architecture of multi-power mode serial interface, the architecture comprises two I/O ports, and a driver and receiver circuit. In the driver and receiver circuit, at least a multi-mode driver generates a group of signals with different currents or voltages to drive the two I/O ports, according to control signals of different transmission modes. A multi-mode terminator circuit provides different terminal impedances, according to control signals of different transmission modes. At least a receiver receives signals from the two I/O ports and shunt from the multi-mode terminator circuit. Wherein, the different transmission modes at least include a USB compatible mode.

### TECHNICAL FIELD

The present disclosure generally relates to an architecture of multi-power mode serial interface.

### BACKGROUND

In the handheld devices, such as, MP3 player, GPS, mobile phone, and digital camera, the power consumption and the energy saving are the important issues to be considered. Nowadays, most handheld devices have built-in USB interface or modules with USB interface functions, such as, flash memory module, digital camera module, MIC module, and global system for mobile communications (GSM) module. Because USB transmission interface consumes much power, there are many examples that USB interface consumes more power than the main function, such as, MP3 player and navigation computation of GPS, of the handheld device.

In the USB application, the power-consumption issue comes from two reasons. The first reason is the receiving end uses resistor to suppress the signal reflection effect so as to reduce the overshoot and undershoot caused by signal reflection to the minimum. The other reason is that a long wire, such as, cable, is often used between transmission end and the receiving end. In many USB applications, such as, embedded system, the distance between host and the device is far less than the typical 1.8m cable. Under such circumstances, the transceivers of USB host and the device may operate in the lower power mode to reduce the overall power consumption for the system. In current handheld devices, many USB modules or USB devices do not use cables. Hence, when a long wire is not needed in a USB application, the USB interfaces of the host and the device do not need to activate the USB PHY layer, or only need to operate the PHY layer in the lower power mode. In this manner, all the USB link layer signals are the same as the signals defined in the standard of communication protocol. Therefore, the driver does not need major modification. Because the USB PHY layer is not activated, or the PHY layer operates in a lower power mode, the USB interface may save overall energy. When a long wire is used to connect the USB interfaces between host and the device, the USB interface will activate the standard full-power USB PHY layer to drive the USB cable and the USB device.

U.S. Pat. No. 7,606,947 disclosed a removable electronic device, for supporting the compatible operation mode of the USB, multimedia card (MMC) applications. AS shown in FIG. 1, in removable electronic device 100, interface mode detector 132 is used to detect MMC compatible mode, USB compatible mode and Mu mode. Wrapper 135 is used to translate data for transmission between USB compatible mode and Mu mode. USB PHY layer circuit 136 is used to transmit data compatible to USB compatible mode. USB device controller 137 is used to control the data transmission of USB compatible mode. MMC device controller 134 is used to control the data transmission of MMC compatible mode.

Removable electronic device 100 may switch between using PHY and using a bit data and a clock digital signal of Mu mode on the USB device for data transmission, wherein the data and clock digital signal wire of Mu mode are single end signal. When using Mu mode for data transmission, the energy is saved because the power-consumption PHY layer is not used.

### SUMMARY

The disclosed exemplary embodiments may provide an architecture of multi-power mode serial interface.

In an exemplary embodiment, the architecture of multi-power mode serial interface comprises two I/O ports, and a driver and receiver circuit. In the driver and receiver circuit, at least a multi-mode driver generates a group of signals with different currents or voltages to drive the two I/O ports, according to control signals of different transmission modes. A multi-mode terminator circuit provides different terminal impedances, according to control signals of different transmission modes. At least a receiver receives signals from the two I/O ports and shunt from the multi-mode terminator circuit. Wherein, the different transmission modes at least include a USB compatible mode. The two I/O ports are electrically connected to the multi-mode terminator circuit and the at least a receiver. The multi-mode terminator circuit is electrically connected to the multi-mode driver.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows an exemplary schematic view of a removable electronic device.

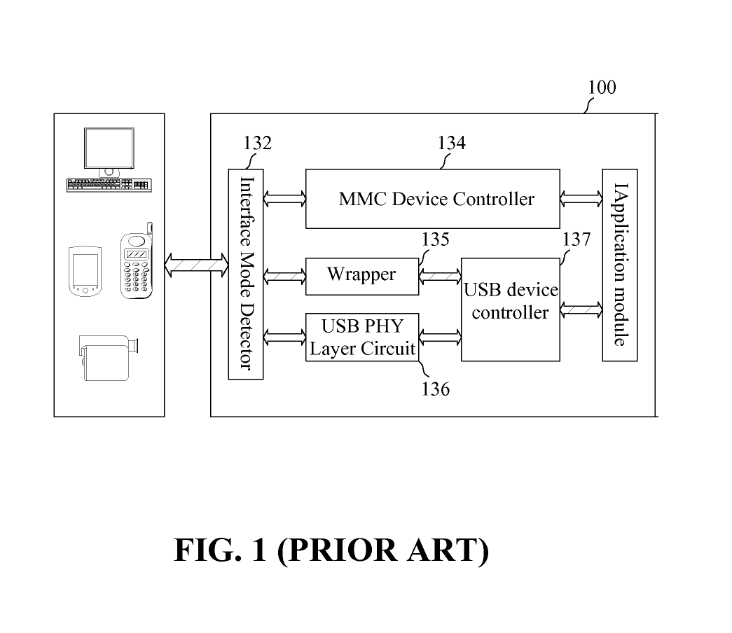

FIG. 2 shows an exemplary schematic view of a serial interface architecture, consistent with certain disclosed embodiments.

FIG. 3 shows an exemplary schematic view of a working exemplar of the serial interface architecture, consistent with certain disclosed embodiments.

FIG. 4 shows an exemplary schematic view of another working exemplar of the serial interface architecture, consistent with certain disclosed embodiments.

### DETAILED DESCRIPTION OF THE EXEMPLARY EMBODIMENTS

The disclosed exemplary embodiments establish a serial interface architecture in USB applications, with configurable or programmable voltage or current source and terminator circuit, and is compatible with the original USB connector as well as applicable to the USB standard cable length in the application of removable devices. In the situation of the cable length of mobile device application, a low-power mode operation may be used to achieve the requirement of energy saving for mobile devices.

The serial interface architecture may operate in many scenarios, at least including, connection wire of different lengths or different data transfer rates between the USB host and the USB device, and configurable or programmable voltage or current source so that the power consumption of the USB host and the USB device is optimized.

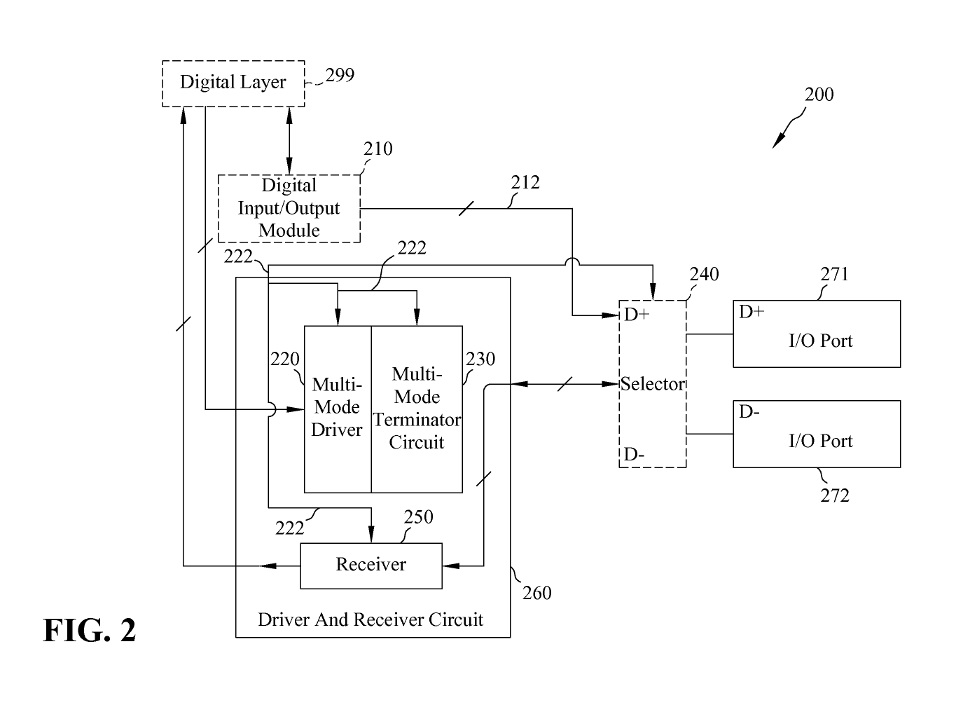

FIG. 2 shows an exemplary schematic view of a serial interface architecture, consistent with certain disclosed embodiments. In FIG. 2, serial interface architecture 200 comprises two I/O ports 271, 272, and a driver and receiver circuit 260. Driver and receiver circuit 260 further includes at least a multi-mode differential driver 220, a multi-mode terminator circuit 230 and at least a receiver 250.

According to control signals 222 of different transmission modes, at least a multi-mode differential driver 220 uses different current or voltage to generate a set of signals to drive two I/O ports 271, 272. At least a multi-mode driver 220 may use a differential mode for data transmission or receiving. The different transmission modes at least include a USB compatible mode.

According to control signals 22 of different transmission modes, multi-mode terminator circuit 230 provides different terminal impedances. The different terminal impedances may include adjustable output serial impedance, or adjustable input parallel terminal impedances. Multi-mode terminator circuit 230 is electrically connected to at least a multi-mode driver 220. At least a multi-mode driver 220 and multi-mode terminator circuit 230 may also be realized with a single integrated circuit.

When driver 220 transmits signals, multi-mode terminator circuit 230 may adjust the output serial impedance and suppress reflection signal according to different cable lengths and different transmission rates.

At least a receiver 250 receives signals from two I/O ports 271, 272. When receiving signals, multi-mode terminator circuit 230 may adjust the output serial impedance and suppress reflection signal according to the different cable lengths and different transmission rates. Two I/O ports 271, 272 are both electrically connected to multi-mode terminator circuit 230 and at least a receiver 250.

Serial interface architecture 200 may further include a digital I/O module 210 and at least a selector 240. Digital I/O module 210 is electrically connected to a digital layer 299 of a USB controller, and has a plurality of digital Inputs/Outputs (I/Os) 212. According to control signals 222 of different transmission modes, at least a selector 240 selects whether two I/O ports 271, 272 should be connected to driver and receiving circuit 260 or to the plurality of digital I/Os 212. The plurality of digital I/Os 212 is electrically connected to at least a selector 240. Digital I/O module 210 may also use a differential mode for data transmission and receiving. Two I/O ports 271, 272 uses a digital plus signal D+ or a digital minus signal D− for input/output.

Digital I/O 212 may have two digital signal outputs, including a digital single end data signal and a digital end clock signal, or two digital differential data signals.

In the exemplary embodiments, serial interface architecture 200 may provide three different operation modes for USB compatible data transmission: high speed (HS), full speed (FS) and low speed (LS). The definitions of HS, FS and LS data transmission rates are the same as the standard USB. In other words, 480 MHz, 12 MHz, 1.5 MHz are defined as HS, FS and LS transmission rates. Serial interface architecture 200 can further provide operation modes of different transmission rates.

Serial interface architecture 200 is compatible with a transceiver of a USB host controller/system or a USB device controller/system. The transceiver may be configured to a multi-power mode transceiver. Before a normal USB transaction processing starts, serial interface architecture 200 must determine the mode configuration according to the operation of the USB host and USB device. The operation of the USB host and the USB device is determined by the wire length or data transmission rate between the USB host and the USB device.

As aforementioned, serial interface architecture 200 can provide the USB compatible modes for three operation modes of HS, FS and LS data transmission rates. The following describes the decision of the mode configuration, wherein the general standard USB is, such as, USB 2.0.

(1) In LS/FS mode, the topology of serial interface architecture 200 is the same as standard USB, and the voltage source of serial interface architecture 200 may be lower, such as, 1.2-3.3 volts, so as to reduce power-consumption.

(2) In LS/FS mode, the host selects a set of frequencies at which both the host and the device may operate well from a set of pre-defined frequencies, such as, 1.5/12 MHz or other operating frequencies with spectrum within 1.5 MHz-12 MHz, the host-defined value as 12 MHz, where the data transmission rate can vary between 1.5 MHz and 12 Mhz. The signal quality depends on the wire length between USB host transceiver and USB device transceiver.

(3) In LS/FS mode, when establishing connection, the deviated speed can be defined through the application requirements or test packet negotiation to evaluate the bit error rate and assure the signal quality.

(4) In HS/LS/FS mode, as long as the signal quality is acceptable, the transceiver with the disclosed serial interface architecture 200 may provide a single ended mode for data wire and clock wire to replace the digital plus signal wire D+ or digital minus signal wire D− of a standard USB. The signal quality depends on the wire length between the USB host transceiver and the USB device transceiver.

(5) In HS mode, the host selects a set of frequencies at which both the host and the device can operate well from a set of pre-defined frequencies, such as, 12/60/120/240/480 MHz or other operating frequencies with spectrum within 12 MHz-480 MHz, the host-defined value as 480 MHz, where the data transmission rate may vary between 12 MHz and 480 Mhz. when the signal quality is acceptable, the data transmission rate may vary between 480 MHz to lower than 480 MHz. The signal quality depends on the wire length between USB host transceiver and USB device transceiver.

(6) In HS mode, in comparison with the driver circuit of a standard USB, multi-mode driver 220 of serial interface architecture 200 operates in a lower current mode, and receiver 250 switches to lower power termination mode.

(7) In HS mode, when establishing connection, the deviated speed may be defined through the application requirements or test packet negotiation to evaluate the bit error rate and assure the signal quality.

(8) Single-ended signaling is a simple and common manner to send electronic signal through wire, wherein a wire carries a voltage change, and the voltage change represents a signal; the other wire is connected to a reference signal, usually, the ground.

(9) The transceiver of USB host and/or USB device, in addition to the standard USB mode, also has configurable lower power mode, including, configurable or programmable driving and termination modes, and configurable or programmable synchronous single end and/or asynchronous differential mode. The synchronous single-end is, such as, the single end data with single end clock.

(10) For varied data transmission rates, the speed can be determined by (3) and (7). This is the definition of multi-mode.

(11) For modified frequency mode, the definition can refer to (2) and (5).

As aforementioned, the disclosed serial interface architecture can be realized in a transceiver of a USB host controller transceiver or a USB device controller. Alternatively, both the host controller or the device controller include the transceiver having the serial interface architecture of the present invention, and the transceiver of the host and the transceiver of the device form symmetric circuit. The transceiver may be configured to a multi power mode. The transceiver of the USB device controller may also be designed with the digital input/output module of the above exemplary embodiment, at least a multi-mode driver, a multi-mode termination circuit, a receiver and at least a selector circuit.

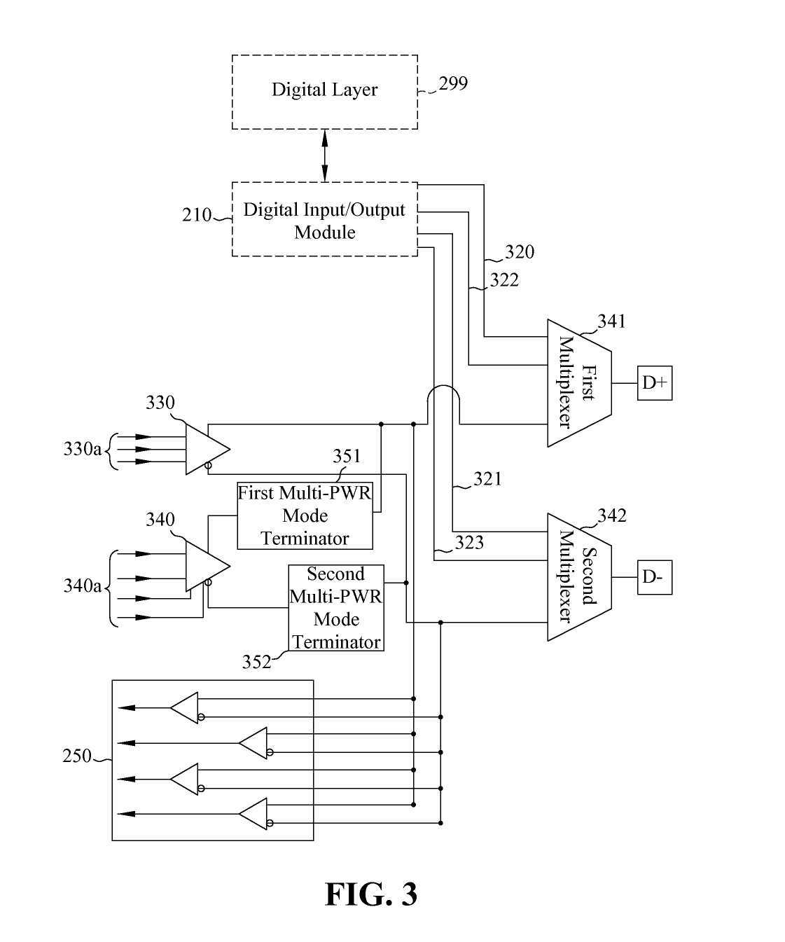

FIG. 3 shows an exemplary schematic view of a working exemplar of the serial interface architecture 200, consistent with certain disclosed embodiments. In FIG. 3, digital output module 210 generates four digital signal outputs, including a digital single end data output 320, a digital single end clock output 322, a digital differential end data output 321, and a digital differential end clock output 323, wherein digital single end data output 320 and digital single end clock output 322 are provided to a first multiplexer 341, and digital differential end data output 321 and digital differential end clock output 323 are provided to a second multiplexer 342.

For HS or deviated HS mode, multi-mode high speed driver 330, via control signal 330a, uses different currents or different volts, and different output impedances to drive in current mode or voltage mode. The multi-mode low/full speed driver 340, via control signal 340a, uses different volts, and different output impedances to drive in voltage mode, and includes a first multi-PWR mode terminator 351 and a second multi-PWR mode terminator 352. Based on the default mode configuration, when receiving signals, driver 340 outputs a fixed level, such as, low level, and the terminators 351, 352 form parallel termination resistance.

When the wire length between the host transceiver and the device transceiver is short, under the circumstance of passing through a certain length of wire at a default transmission rate, as long as the signal quality is with an acceptable bit error rate (BER), the signal receiving does not have to activate parallel termination resistance formed by driver 340, and multi-PWR mode terminators 351, 352; that is, no parallel termination at all, so as to reduce the transmission power consumption.

For LS/FS or deviated LS/FS mode, multi-mode HS driver 430 is turned off. Multi-mode LS/FS driver 340, via control signal 340a, uses different voltage swings to drive according to the default mode configuration and system-provided voltage supply to assure the signal quality still has an acceptable BER after passing through a certain wire length at a default frequency.

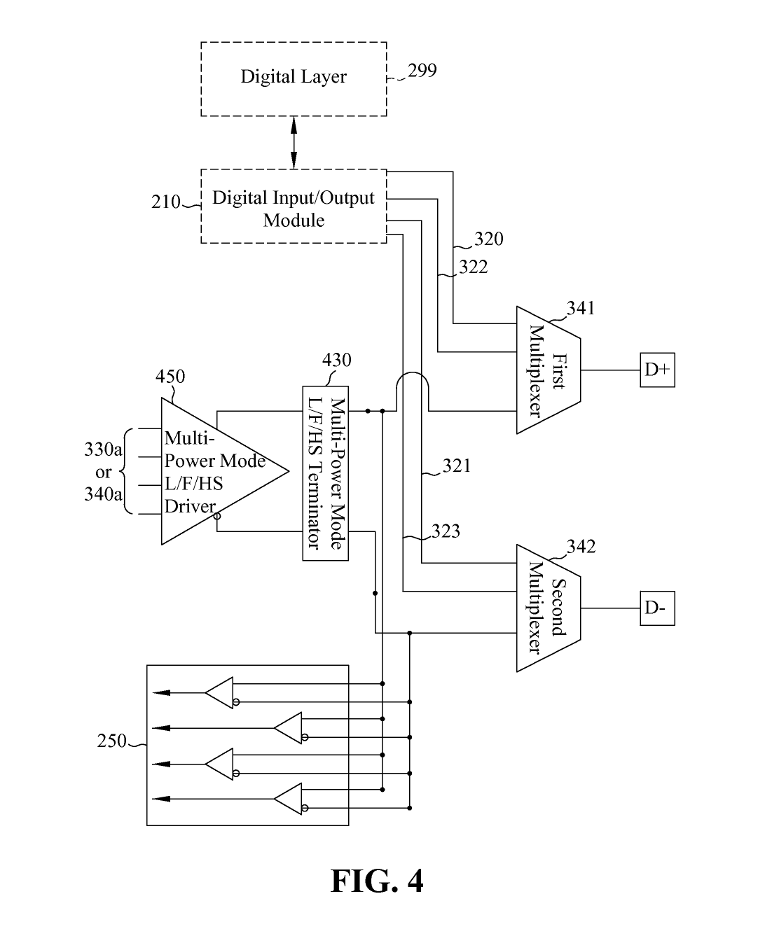

As shown in the working exemplar of FIG. 4, multi-mode HS driver 330 and multi-mode LS/FS driver 340 may also be integrated as a unified driver circuit, that is, a multi-power mode L/F/HS driver 450. Multi-power mode L/F/HS driver 450 may include the capabilities of multi-mode HS driver 330 and multi-mode LS/FS driver 340. For HS or deviated HS mode, multi-power mode L/F/HS driver 450 can use different currents or different volts, and different impedances to drive in current mode or voltage mode. For LS/FS or deviated LS/FS mode, multi-power mode L/F/HS driver 450 will use different voltage swings to drive. Similarly, first multi-PWR terminator 351 and second multi-PWR terminator 352 may be integrated into a unified terminator circuit, such as, a multi-power mode L/F/HS terminator 430, to provide different input parallel termination resistances in different power mode.

The above exemplars show that the transceiver realized by the disclosed serial interface architecture can operate in a plurality of conditions, including different transmission wire lengths, a plurality of data rates and supply voltages, to optimize the power consumption of the USB host and device. The configurable or programmable driving mode may provide different currents in a plurality of current modes for different wire lengths at standard rates or non-standard deviated speeds. The configurable or programmable termination mode may provide different termination resistances, including infinite resistance, i.e., no parallel termination at all, for different wire lengths at standard rates or non-standard deviated speeds. The transceiver is compatible with USB device/system as well as USB host controller/system.

The serial interface architecture of the disclosed embodiments may define a port layout. The port layout may be placed at the controller end of a host transceiver or the controller end of a device transceiver. With the port layout design and FIGS. 3-4, it may be seen that the serial interface architecture of the disclosed embodiments includes multi-mode drivers and multi-mode terminators and optional digital and/or single-ended driver. The single-ended mode provides data wire and clock wire to replace the digital plus signal wire D+ and digital minus signal wire D− of the standard USB, such as, USB 2.0.

In summary, the disclosed embodiments provide a serial interface architecture. The serial interface architecture can be realized in a transceiver of a USB host and/or device. The transceiver can operate in many conditions, at least, including different wire lengths or transmission rates between USB host and USB device, and configurable or programmable voltage or current supplies to reduce the overall power consumption of the USB host and USB device.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An architecture of multi-power mode serial interface, said architecture comprising two I/O ports, and a driver and receiver circuit; said driver and receiver circuit further including:
at least a multi-mode driver that generates a set of signals by using different currents or volts, according to control signals of different transmission modes, to drive said two I/O ports;
a multi-mode terminator circuit electrically connected to said at least a multi-mode driver, for providing different termination impedances according to said control signals of different transmission modes; and
at least a receiver for receiving at least a signal from said two I/O ports and shunt from said multi-mode terminator circuit;
wherein said different transmission modes at least include a USB compatible mode, said two I/O ports are both electrically connected to said multi-mode terminator circuit and said at least a receiver.

2. The architecture as claimed in claim 1, wherein said at least a multi-mode driver and said multi-mode terminator circuit are realized with a single unified circuit.

3. The architecture as claimed in claim 1, wherein said further includes:
a digital input/output module electrically connected to a digital layer of a USB controller, and having a plurality of digital inputs/outputs; and
at least a selector for selecting said two I/O ports to be connected to said driver and receiver circuit or to said plurality of digital inputs/outputs according to said control signals of said different transmission modes;
wherein said plurality of digital inputs/outputs are electrically connected to said at least a selector.

4. The architecture as claimed in claim 1, wherein said different termination impedances include adjustable output serial termination resistance.

5. The architecture as claimed in claim 1, wherein said different termination impedances include adjustable output parallel termination resistance.

6. The architecture as claimed in claim 1, said serial interface architecture at least provides three operation modes compatible to USB existent high speed, full speed and low speed data transmission rates.

7. The architecture as claimed in claim 6, said serial interface architecture further provides a plurality of operation modes of different data transmission rates.

8. The architecture as claimed in claim 1, wherein said at least a multi-mode driver uses a differential mode for data transmission or receiving.

9. The architecture as claimed in claim 1, wherein said digital input/output module uses a differential mode for data transmission or receiving.

10. The architecture as claimed in claim 1, said serial interface architecture further defines a port layout, said port layout is placed at a controller of a host transceiver or a controller of a device transceiver.

11. The architecture as claimed in claim 1, said serial interface architecture is realized in a host or device transceiver.
